(19) United States
(12) Patent Application Publication
(10) Pub. No.: US 2026/0351646 A1
(43) Pub. Date: Nov. 5, 2026

(54) HYDROGEN ELECTRODE-SOLID ELECTROLYTE LAYER COMPOSITE, PROTON-CONDUCTING CELL STRUCTURE, FUEL CELL, STEAM ELECTROLYSIS CELL, AND METHOD OF MANUFACTURING HYDROGEN ELECTRODE-SOLID ELECTROLYTE LAYER COMPOSITE

(71) Applicant: SUMITOMO ELECTRIC INDUSTRIES, LTD., Osaka-shi, Osaka (JP)

(72) Inventors: Naho MIZUHARA, Osaka-shi (JP); Takahiro HIGASHINO, Osaka-shi (JP); Hiromasa TAWARAYAMA, Osaka-shi (JP); Akihisa HOSOE, Osaka-shi (JP)

(73) Assignee: SUMITOMO ELECTRIC INDUSTRIES, LTD., Osaka-shi, Osaka (JP)

(21) Appl. No.: 19/486,096

(22) PCT Filed: Jun. 11, 2024
(86) PCT No.: PCT/JP2024/021128

§ 371 Date: Nov. 20, 2025

(30) Foreign Application Priority Data
Jun. 21, 2023 (JP) 2023-101713

(51) Int. Cl. H01M 8/126; C25B 1/042; C25B 11/031; C25B 11/047; C25B 11/067; C25B 11/075; C25B 13/07; H01M 4/86; H01M 4/88; H01M 4/90; H01M 8/12; H01M 8/1253

(52) U.S. Cl. CPC H01M 8/126; C25B 1/042; C25B 11/031; C25B 11/047; C25B 11/067; C25B 11/075; C25B 13/07; H01M 4/8605; H01M 4/885; H01M 4/8882; H01M 4/9075; H01M 8/1253; H01M 2008/1293

(57) ABSTRACT

A hydrogen electrode-solid electrolyte layer composite according to the present disclosure includes a hydrogen electrode having pores, and a solid electrolyte layer in contact with the hydrogen electrode. The hydrogen electrode and the solid electrolyte layer each contain a metal oxide, the metal oxide has a perovskite structure and is represented by a formula (1) AₓB_{1-y}M_{y}O_{3-δ} (where element A is at least one selected from the group consisting of Ba, Ca, and Sr, element B is at least one selected from the group consisting of Ce and Zr, element M is at least one selected from the group consisting of Y, Yb, Er, Ho, Tm, Gd, In, and Sc, δ is an oxygen deficiency, and 0.95≤x≤1 and 0<y≤0.5 are satisfied).

### TECHNICAL FIELD

The present disclosure relates to a hydrogen electrode-solid electrolyte layer composite, a proton-conducting cell structure, a fuel cell, a steam electrolysis cell, and a method of manufacturing a hydrogen electrode-solid electrolyte layer composite. The present application claims priority based on Japanese Patent Application No. 2023-101713 filed on Jun. 21, 2023, and the entire contents of the Japanese patent application are incorporated herein by reference.

### BACKGROUND ART

PTL 1 discloses a method of manufacturing a hydrogen electrode-solid electrolyte layer composite that can form a proton-conducting cell structure having high current efficiency. According to the manufacturing method described in PTL 1, diffusion of nickel in a solid electrolyte layer is reduced. Therefore, steam electrolysis cells and fuel cells using the hydrogen electrode-solid electrolyte layer composite obtained by the manufacturing method described in PTL 1 exhibit high current efficiency.

### CITATION LIST

### Patent Literature

PTL 1: International Publication No. 2019/107194

### SUMMARY OF INVENTION

An aspect of the present disclosure is a hydrogen electrode-solid electrolyte layer composite including a hydrogen electrode having pores, and a solid electrolyte layer in contact with the hydrogen electrode, wherein the hydrogen electrode and the solid electrolyte layer each contain a metal oxide, and the metal oxide has a perovskite structure and is represented by a formula (1) below:

AₓB_{1-y}M_{y}O_{3-δ} (1)

(where element A is at least one selected from the group consisting of Ba, Ca, and Sr, element B is at least one selected from the group consisting of Ce and Zr, element M is at least one selected from the group consisting of Y, Yb, Er, Ho, Tm, Gd, In, and Sc, δ is an oxygen deficiency, and 0.95≤x≤1 and 0<y≤0.5 are satisfied). The hydrogen electrode has a nickel component in the pores, the pores have a first average diameter or a second average diameter, in a cross-sectional view parallel to a thickness direction of the hydrogen electrode, the first average diameter is an average value of outer diameters of 10 pores having the largest outer diameters among 100 pores having 70% or more of their outer circumferences visually recognizable and selected in a region from a contact surface between the hydrogen electrode and the solid electrolyte layer to a depth of 50 μm, and the second average diameter is an average value of outer diameters of 10 pores having the largest outer diameters among 20 pores having 70% or more of their outer circumferences visually recognizable and selected in a region from a surface of the hydrogen electrode opposite to the contact surface to a depth of 200 μm, and the first average diameter is smaller than the second average diameter.

Another aspect of the present disclosure relates to a proton-conducting cell structure including the hydrogen electrode-solid electrolyte layer composite according to the present disclosure and a porous oxygen electrode in contact with the solid electrolyte layer, wherein the solid electrolyte layer is disposed between the oxygen electrode and the hydrogen electrode, and the oxygen electrode is composed of a compound having a perovskite structure.

Still another aspect of the present disclosure relates to a fuel cell including the proton-conducting cell structure according to the present disclosure.

Still another aspect of the present disclosure relates to a steam electrolysis cell including the proton-conducting cell structure according to the present disclosure.

Still another aspect of the present disclosure relates to a method of manufacturing a hydrogen electrode-solid electrolyte layer composite. The method of manufacturing a hydrogen electrode-solid electrolyte layer composite is a method of manufacturing a hydrogen electrode-solid electrolyte layer composite including a hydrogen electrode having pores, and a solid electrolyte layer in contact with the hydrogen electrode, the method including a first step of preparing a first paste sheet serving as a precursor of the solid electrolyte layer, and a second paste sheet and a third paste sheet serving as precursors of the hydrogen electrode; a second step of stacking the first paste sheet, the second paste sheet, and the third paste sheet in an order of the first paste sheet, the second paste sheet, and the third paste sheet to obtain a paste sheet laminate; a third step of heat-treating the paste sheet laminate to obtain a sintered body; a fourth step of impregnating the sintered body with a nickel compound solution to obtain a nickel-impregnated sintered body; and a fifth step of heat-treating the nickel-impregnated sintered body to obtain a hydrogen electrode-solid electrolyte layer composite. The first paste sheet contains a metal oxide, and the metal oxide has a perovskite structure and is represented by a formula (1) below:

AₓB_{1-y}M_{y}O_{3-δ} (1)

(where element A is at least one selected from the group consisting of Ba, Ca, and Sr, element B is at least one selected from the group consisting of Ce and Zr, element M is at least one selected from the group consisting of Y, Yb, Er, Ho, Tm, Gd, In, and Sc, δ is an oxygen deficiency, and 0.95≤x≤1 and 0<y≤0.5 are satisfied). The second paste sheet contains the metal oxide and a first pore-forming material having a first median diameter. The third paste sheet contains the metal oxide and a second pore-forming material having a second median diameter. The first median diameter is smaller than the second median diameter.

### BRIEF DESCRIPTION OF DRAWINGS

FIG. 1 is a scanning electron micrograph showing a cross section of a hydrogen electrode-solid electrolyte layer composite according to the present embodiment.

FIG. 2 is an enlarged photograph of the vicinity of a contact surface of FIG. 1.

FIG. 3 is an enlarged photograph of the vicinity of a hydrogen electrode surface of FIG. 1.

FIG. 4 is an explanatory view of a porosity, an application ratio, and an impregnation ratio.

FIG. 5 is a flowchart of a method of manufacturing a hydrogen electrode-solid electrolyte layer composite.

FIG. 6 is a schematic view of a proton-conducting cell structure including a hydrogen electrode-solid electrolyte layer composite according to the present embodiment.

FIG. 7 is a schematic view of a fuel cell including a proton-conducting cell structure according to the present embodiment.

### DETAILED DESCRIPTION

### Problems to be Solved by Present Disclosure

The performance of steam electrolysis cells and fuel cells is improving on a daily basis. Therefore, further improvements in the current efficiency and the power density of proton-conducting cell structures have been desired.

An object of the present disclosure is to provide a hydrogen electrode-solid electrolyte layer composite for forming a proton-conducting cell structure having high current efficiency and power density. Another object of the present disclosure is to provide a proton-conducting cell structure including the hydrogen electrode-solid electrolyte layer composite. Still another object of the present disclosure is to provide a fuel cell and a steam electrolysis cell that include the proton-conducting cell structure. Still another object of the present disclosure is to provide a method of manufacturing the hydrogen electrode-solid electrolyte layer composite.

### Advantageous Effects of Present Disclosure

The present disclosure can provide a hydrogen electrode-solid electrolyte layer composite for forming a proton-conducting cell structure having high current efficiency and power density. The present disclosure can further provide a proton-conducting cell structure including the hydrogen electrode-solid electrolyte layer composite. Furthermore, the present disclosure can provide a fuel cell and a steam electrolysis cell that include the proton-conducting cell structure. In addition, the present disclosure can provide a method of manufacturing the hydrogen electrode-solid electrolyte layer composite.

### Description of Embodiments of Present Disclosure

First, the contents of embodiments of the present disclosure will be listed and described.

(1) A hydrogen electrode-solid electrolyte layer composite according to an embodiment of the present disclosure is a hydrogen electrode-solid electrolyte layer composite including a hydrogen electrode having pores, and a solid electrolyte layer in contact with the hydrogen electrode, in which the hydrogen electrode and the solid electrolyte layer each contain a metal oxide, and the metal oxide has a perovskite structure and is represented by a formula (1) below:

AₓB_{1-y}M_{y}O_{3-δ} (1)

(where element A is at least one selected from the group consisting of Ba, Ca, and Sr, element B is at least one selected from the group consisting of Ce and Zr, element M is at least one selected from the group consisting of Y, Yb, Er, Ho, Tm, Gd, In, and Sc, δ is an oxygen deficiency, and 0.95≤x≤1 and 0<y≤0.5 are satisfied). The hydrogen electrode has a nickel component in the pores, and the pores have a first average diameter or a second average diameter. In a cross-sectional view parallel to a thickness direction of the hydrogen electrode, the first average diameter is an average value of outer diameters of 10 pores having the largest outer diameters among 100 pores having 70% or more of their outer circumferences visually recognizable and selected in a region from a contact surface between the hydrogen electrode and the solid electrolyte layer to a depth of 50 μm, and the second average diameter is an average value of outer diameters of 10 pores having the largest outer diameters among 20 pores having 70% or more of their outer circumferences visually recognizable and selected in a region from a surface of the hydrogen electrode opposite to the contact surface to a depth of 200 μm, and the first average diameter is smaller than the second average diameter.

According to the hydrogen electrode-solid electrolyte layer composite described in (1) above, a proton-conducting cell structure having high current efficiency and power density can be formed.

(2) In the hydrogen electrode-solid electrolyte layer composite of (1) above, a ratio of the second average diameter to the first average diameter (second average diameter/first average diameter) may be 2.0 to 10.

(3) In the hydrogen electrode-solid electrolyte layer composite of (1) or (2) above, the first average diameter may be 10 μm to 40 μm, and the second average diameter may be 30 μm to 200 μm.

(4) In the hydrogen electrode-solid electrolyte layer composite of any one of (1) to (3) above, the hydrogen electrode may include a first area including the contact surface, a second area including the surface, and a boundary surface between the first area and the second area, the first area may have a porosity of 60% to 90%, and the second area may have a porosity of 40% to 90%.

(5) In the hydrogen electrode-solid electrolyte layer composite of any one of (1) to (4) above, the hydrogen electrode may include a first area including the contact surface, a second area including the surface, and a boundary surface between the first area and the second area, an average film thickness from the contact surface to the boundary surface may be 50 μm to 300 μm, and an average film thickness from the surface to the boundary surface may be 200 μm to 1,000 μm.

(6) In the hydrogen electrode-solid electrolyte layer composite of any one of (1) to (5) above, an application ratio of the nickel component in the pores in the first area may be 20% to 75%.

(7) In the hydrogen electrode-solid electrolyte layer composite of any one of (1) to (6) above, an impregnation ratio of the nickel component in the pores in the first area may be 15% or more and less than 45%.

(8) In the hydrogen electrode-solid electrolyte layer composite of any one of (1) to (7) above, element A may be Ba, element B may be Zr, and element M may be Y or Yb.

According to the hydrogen electrode-solid electrolyte layer composites of (2) to (8) above, a proton-conducting cell structure having higher current efficiency and power density can be formed.

(9) A proton-conducting cell structure according to another embodiment of the present disclosure includes the hydrogen electrode-solid electrolyte layer composite of any one of (1) to (8) above and a porous oxygen electrode in contact with the solid electrolyte layer, in which the solid electrolyte layer is disposed between the oxygen electrode and the hydrogen electrode, and the oxygen electrode is composed of a compound having a perovskite structure.

The proton-conducting cell structure of (9) above has high current efficiency and power density.

(10) In the proton-conducting cell structure of (9) above, the oxygen electrode may be composed of lanthanum strontium cobalt ferrite or lanthanum strontium cobaltite.

The proton-conducting cell structure of (10) above has higher current efficiency and power density.

(11) A fuel cell according to another embodiment of the present disclosure includes the proton-conducting cell structure described in (9) or (10) above.

(12) A steam electrolysis cell according to another embodiment of the present disclosure includes the proton-conducting cell structure described in (9) or (10) above.

The fuel cell of (11) above and the steam electrolysis cell of (12) above each include a proton-conducting cell structure having high current efficiency and power density.

(13) A method of manufacturing a hydrogen electrode-solid electrolyte layer composite according to another embodiment of the present disclosure is a method of manufacturing a hydrogen electrode-solid electrolyte layer composite including a hydrogen electrode having pores, and a solid electrolyte layer in contact with the hydrogen electrode, the method including a first step of preparing a first paste sheet serving as a precursor of the solid electrolyte layer, and a second paste sheet and a third paste sheet serving as precursors of the hydrogen electrode; a second step of stacking the first paste sheet, the second paste sheet, and the third paste sheet in an order of the first paste sheet, the second paste sheet, and the third paste sheet to obtain a paste sheet laminate; a third step of heat-treating the paste sheet laminate to obtain a sintered body; a fourth step of impregnating the sintered body with a nickel compound solution to obtain a nickel-impregnated sintered body; and a fifth step of heat-treating the nickel-impregnated sintered body to obtain a hydrogen electrode-solid electrolyte layer composite. The first paste sheet contains a metal oxide, and the metal oxide has a perovskite structure and is represented by a formula (1) below:

AₓB_{1-y}M_{y}O_{3-δ} (1)

(where element A is at least one selected from the group consisting of Ba, Ca, and Sr, element B is at least one selected from the group consisting of Ce and Zr, element M is at least one selected from the group consisting of Y, Yb, Er, Ho, Tm, Gd, In, and Sc, δ is an oxygen deficiency, and 0.95≤x≤1 and 0<y≤0.5 are satisfied). The second paste sheet contains the metal oxide and a first pore-forming material having a first median diameter, and the third paste sheet contains the metal oxide and a second pore-forming material having a second median diameter. The first median diameter is smaller than the second median diameter.

The manufacturing method of (13) above can manufacture a hydrogen electrode-solid electrolyte layer composite that can form a proton-conducting cell structure having high current efficiency and power density.

(14) In the manufacturing method of (13) above, the third step may include heat-treating the paste sheet laminate at 400 °C to 1,000 °C to remove at least part of the first pore-forming material and the second pore-forming material, and subsequently heat-treating the paste sheet laminate at 1,400 °C to 1,650 °C to obtain the sintered body.

(15) In the manufacturing method of (13) or (14) above, the fifth step may include heat-treating the nickel-impregnated sintered body at 200 °C to 600 °C to fix a nickel component in pores of the hydrogen electrode, thereby obtaining the hydrogen electrode-solid electrolyte layer composite.

(16) In the manufacturing method of any one of (13) to (15) above, a ratio of the second median diameter to the first median diameter (second median diameter/first median diameter) may be 2.5 to 10.

(17) In the manufacturing method of (16) above, the first median diameter may be 15 μm to 50 μm, and the second median diameter may be 30 μm to 200 μm.

According to the manufacturing method of any one of (14) to (17) above, it is possible to manufacture a hydrogen electrode-solid electrolyte layer composite that can form a proton-conducting cell structure having higher current efficiency and power density.

### [Details of Embodiments of Present Disclosure]

Embodiments of the present disclosure will be described below with reference to the drawings as appropriate. It should be noted that the present invention is not limited to these examples. The scope of the present invention is defined by the appended claims and is intended to include all modifications that fall within the scope of the claims and the equivalents thereof.

### [Hydrogen Electrode-Solid Electrolyte Layer Composite]

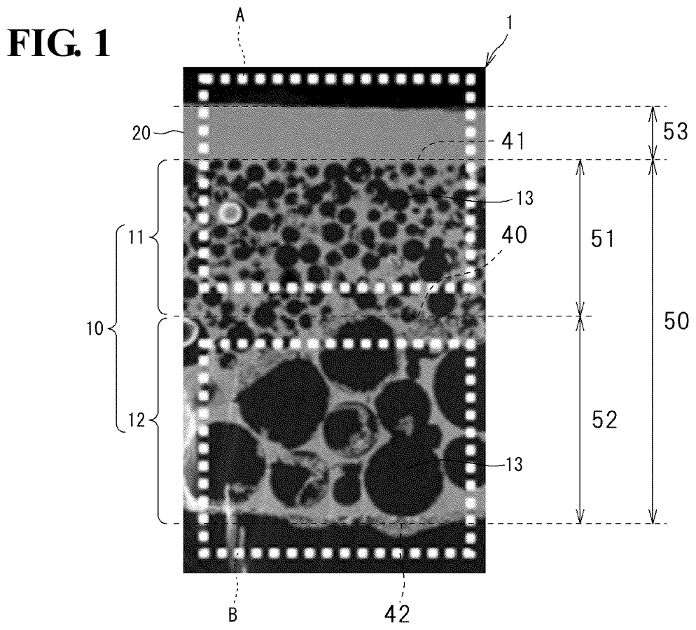

FIG. 1 is a scanning electron micrograph showing a cross section (hereinafter, may be simply referred to as a “cross-sectional SEM photograph”) of a hydrogen electrode-solid electrolyte layer composite according to the present embodiment. A hydrogen electrode-solid electrolyte layer composite 1 shown in FIG. 1 includes a hydrogen electrode 10 having pores 13, and a solid electrolyte layer 20. The hydrogen electrode 10 is porous. The solid electrolyte layer 20 is dense. The hydrogen electrode 10 and the solid electrolyte layer 20 are adjacent and in contact with each other at a contact surface 41. The hydrogen electrode 10 includes a first area 11 having the contact surface 41. The hydrogen electrode 10 includes a second area 12 having a hydrogen electrode surface 42, which is a surface of the hydrogen electrode. The first area and the second area are adjacent and in contact with each other at a boundary surface 40.

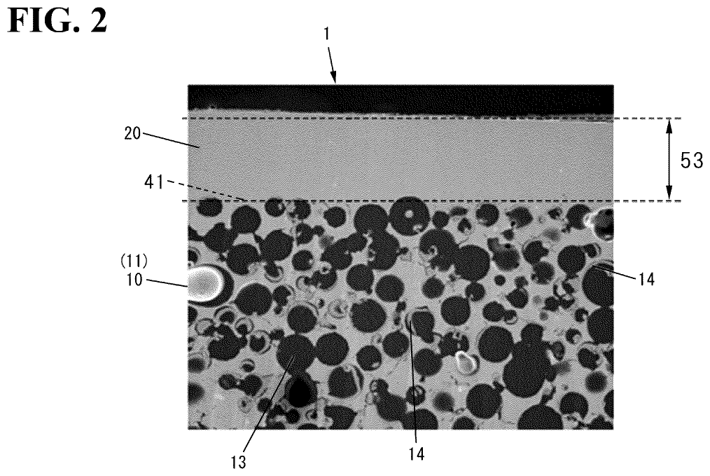

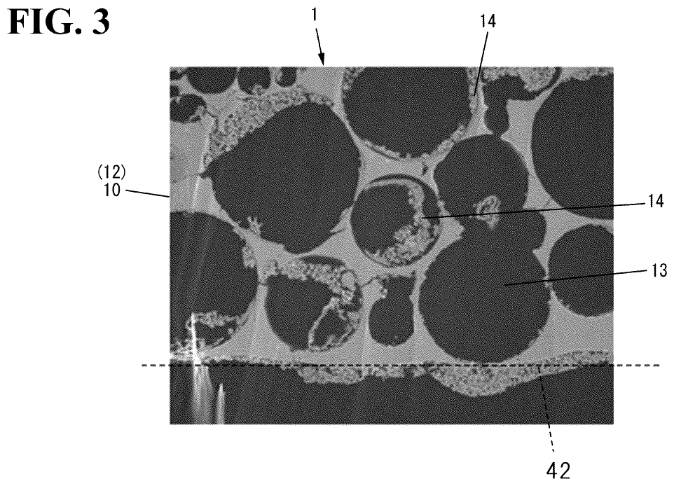

FIG. 2 is an enlarged photograph of the vicinity of the contact surface 41 surrounded by dotted line A in FIG. 1. FIG. 3 is an enlarged photograph of the vicinity of the hydrogen electrode surface 42 surrounded by dotted line B in FIG. 1. As shown in FIGS. 2 and 3, the hydrogen electrode 10 has a nickel component 14 in the pores 13. Herein, the nickel component 14 refers to a component determined to be nickel by SEM-EDX.

The hydrogen electrode-solid electrolyte layer composite 1 is configured such that outer diameters of the pores 13 present in the first area 11 are smaller than outer diameters of the pores 13 present in the second area 12. That is, in the hydrogen electrode-solid electrolyte layer composite 1, a first average diameter of the pores 13 present in the first area 11 is smaller than a second average diameter of the pores 13 present in the second area 12. This enables the hydrogen electrode-solid electrolyte layer composite 1 to form a proton-conducting cell structure having high current efficiency and power density.

Herein, the first average diameter is, in a cross-sectional view parallel to a thickness direction of the hydrogen electrode 10, an average value of outer diameters of 10 pores 13 having the largest outer diameters among 100 pores 13 having 70% or more of their outer circumferences visually recognizable and selected in a region from the contact surface 41 to a depth of 50 μm in the hydrogen electrode 10. Herein, the “pores 13 having 70% or more of their outer circumferences visually recognizable” are pores 13 having 70% or more of their outer circumferences that can be visually recognized in a cross-sectional SEM photograph. Specifically, the first average diameter is obtained by the following procedure of (A-1) to (A-5). It should be noted that the outer diameter of a pore 13 is the outermost diameter of the pore 13. The “outermost diameter” is the diameter of a circle when the cross-sectional shape of the pore 13 is a perfect circle, and is the maximum length among the distances between two points on the outer circumference when the cross-sectional shape is not a perfect circle.
(A-1) In a region from the contact surface 41 to a depth of 50 μm, a cross-sectional SEM photograph of the hydrogen electrode-solid electrolyte layer composite 1 including 100 or more pores 13 having 70% or more of their outer circumferences visually recognizable is obtained.
(A-2) From the obtained cross-sectional SEM photograph, 100 pores 13 are selected.
(A-3) The outer diameters of the selected 100 pores 13 are measured.
(A-4) Of the measured outer diameters, 10 largest outer diameters are extracted.
(A-5) The average value of the extracted 10 outer diameters is obtained as the first average diameter.

The second average diameter is, in a cross-sectional view parallel to the thickness direction of the hydrogen electrode 10, an average value of outer diameters of 10 pores 13 having the largest outer diameters among 20 pores 13 having 70% or more of their outer circumferences visually recognizable and selected in a region from the hydrogen electrode surface 42 to a depth of 200 μm. Specifically, the second average diameter is obtained by the following procedure of (B-1) to (B-5).
(B-1) In a region from the hydrogen electrode surface 42 to a depth of 200 μm, a cross-sectional SEM photograph of the hydrogen electrode-solid electrolyte layer composite 1 including 20 or more pores 13 having 70% or more of their outer circumferences visually recognizable is obtained.
(B-2) From the obtained cross-sectional SEM photograph, 20 pores 13 are selected.
(B-3) The outer diameters of the selected 20 pores 13 are measured.
(B-4) Of the measured outer diameters, 10 largest outer diameters are extracted.
(B-5) The average value of the extracted 10 outer diameters is obtained as the second average diameter.

A ratio of the second average diameter to the first average diameter (second average diameter/first average diameter) can be 2.0 to 10, in particular, 2.0 to 8. In the ratio, the first average diameter can be 10 μm to 40 μm, in particular, 10 μm to 35 μm. In the ratio, the second average diameter can be 30 μm to 200 μm, in particular, 30 μm to 125 μm. This enables the hydrogen electrode-solid electrolyte layer composite 1 to form a proton-conducting cell structure having higher current efficiency and power density.

In FIG. 1, an average film thickness of the first area 11 from the contact surface 41 to the boundary surface 40 is a first average film thickness 51. The first average film thickness 51 can be 50 μm to 300 μm. An average film thickness of the second area 12 from the hydrogen electrode surface 42 to the boundary surface 40 is a second average film thickness 52. The second average film thickness 52 can be 200 μm to 1,000 μm. An average film thickness 50 of the hydrogen electrode 10 can be 250 μm to 1,300 μm. An average film thickness 53 of the solid electrolyte layer 20 can be 20 μm to 40 μm. The average film thicknesses are each an average value determined by measuring the film thickness at three points in the same field of view.

### (Metal Oxide Having Perovskite Structure)

The hydrogen electrode 10 and the solid electrolyte layer 20 each contain a metal oxide. The metal oxide has a perovskite structure and is represented by a formula (1) below.

AₓB_{1-y}M_{y}O_{3-δ} (1)

The A site is occupied by element A, and the B site is occupied by element B (which does not represent boron). The B site is partially replaced by element M from the viewpoint of ensuring a high proton conductivity.

The proportion x of element A relative to the total of element B and element M can be 0.95≤x≤1, in particular, 0.98≤x≤1. This ensures high proton conductivity and ion transport number. In addition, since x does not exceed 1, precipitation of element A is suppressed, and corrosion of the metal oxide due to the action of moisture is suppressed. The proportion y of element M can be 0<y≤0.5, in particular, 0.1<y≤0.3. This ensures proton conductivity. An oxygen deficiency δ is determined in accordance with the proportion y of element M. For example, the oxygen deficiency δ is 0≤δ≤0.15. The proportion of each element in the metal oxide can be determined by, for example, wavelength-dispersive X-ray spectroscopy with an electron-probe microanalyzer.

Element A is at least one selected from the group consisting of Ba (barium), Ca (calcium), and Sr (strontium). Element A can include Ba. This provides good proton conductivity. The proportion of Ba in element A can be 50 at % or more, in particular, 80 at % or more. Element A can be constituted by Ba alone.

Element B is at least one selected from the group consisting of Ce (cerium) and Zr (zirconium). Element B can include Zr. This improves durability of the hydrogen electrode 10 and the solid electrolyte layer 20. The proportion of Zr in element B can be 50 at % or more, in particular, 80 at % or more. Element B can be constituted by Zr alone.

Element M is at least one selected from the group consisting of Y (yttrium), Yb (ytterbium), Er (erbium), Ho (holmium), Tm (thulium), Gd (gadolinium), In (indium), and Sc (scandium). Element M is a dopant. This generates the oxygen deficiency, and the metal oxide having a perovskite structure exhibits proton conductivity.

Specific examples of the metal oxide having a perovskite structure include barium zirconate doped with yttrium [BaₓZr_{1-y}Y_{y}O_{3-δ}] (hereinafter, may be simply referred to as “BZY”), barium zirconate doped with ytterbium [BaₓZr_{1-y}Yb_{y}O_{3-δ}] (hereinafter, may be simply referred to as “BZYb”), barium cerate doped with yttrium [BaₓCe_{1-y}Y_{y}O_{3-δ}], and a mixed oxide of barium zirconate/barium cerate doped with yttrium [BaₓZr_{1-y-z}Ce_{z}Y_{y}O_{3-δ}]. The hydrogen electrode 10 and the solid electrolyte layer 20 can include at least one selected from BZY and BZYb.

### (Porosity, Application Ratio, and Impregnation Ratio)

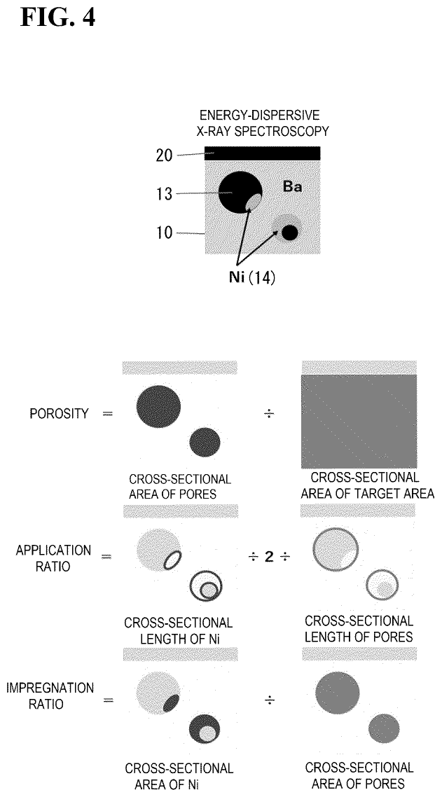

FIG. 4 is an explanatory view of a porosity, an application ratio, and an impregnation ratio. On the upper side of FIG. 4, a schematic view showing the results of energy-dispersive X-ray spectroscopy (hereinafter, may be simply referred to as “EDX”) of a hydrogen electrode-solid electrolyte layer composite 1 is illustrated. On the lower side of FIG. 4, in order from top to bottom, a schematic view that visually represents a calculation formula of the porosity, a schematic view that visually represents a calculation formula of the application ratio, and a schematic view that visually represents a calculation formula of the impregnation ratio are illustrated.

In determination of the porosity, the application ratio, and the impregnation ratio, a mapping image is obtained in which Ba and Ni in the hydrogen electrode-solid electrolyte layer composite 1 are mapped by EDX. Next, an analysis image is obtained in which pores 13 and a nickel component 14 in the mapping image are analyzed. The analysis of the pores 13 and the nickel component 14 in the mapping image was conducted by a general program built with Python (registered trademark). The porosity, the application ratio, and the impregnation ratio are determined on the basis of the obtained analysis image.

The porosity is a value that indicates a proportion of the pores 13 in a target area of a hydrogen electrode 10. The porosity is calculated from a cross-sectional area of the pores 13 and a cross-sectional area of the target area that are obtained from the analysis image described above. The calculation formula of the porosity is represented by a formula (2) below. Note that, in the case of expressing the porosity as a percentage, the value obtained by the formula (2) below is multiplied by 100.

Porosity=cross-sectional area of pores/cross-sectional area of target area (2)

The application ratio is a value that indicates a proportion of a region covered with the nickel component 14 in the inner surfaces of the pores 13. The application ratio is calculated from a cross-sectional length of the nickel component 14 and a cross-sectional length of the pores 13 that are obtained from the analysis image described above. Here, the cross-sectional length of the pores 13 is the length of the outer circumferences of cross sections of the pores 13. The cross-sectional length of the nickel component 14 is the length of the perimeter surrounding the region of the nickel component 14 in the cross sections of the pores 13. The calculation formula of the application ratio is represented by a formula (3) below. Note that, in the case of expressing the application ratio as a percentage, the value obtained by the formula (3) below is multiplied by 100.

Application ratio=cross-sectional length of nickel component/2/cross-sectional length of pores (3)

The impregnation ratio is a value that indicates a proportion of the nickel component 14 in the pores 13. The impregnation ratio is calculated from a cross-sectional area of the nickel component 14 and the cross-sectional area of the pores that are obtained from the analysis image described above. The calculation formula of the impregnation ratio is represented by a formula (4) below. Note that, in the case of expressing the impregnation ratio as a percentage, the value obtained by the formula (4) below is multiplied by 100.

Impregnation ratio=cross-sectional area of nickel component/cross-sectional area of pores (4)

In the hydrogen electrode-solid electrolyte layer composite 1, the porosity in the first area 11 can be 60% to 90%, in particular, 60% to 80%. The porosity in the second area 12 can be 40% to 90%, in particular, 40% to 80%. This enables the hydrogen electrode-solid electrolyte layer composite 1 to form a proton-conducting cell structure having higher current efficiency and power density.

In the hydrogen electrode-solid electrolyte layer composite 1, the application ratio of the nickel component 14 in the hydrogen electrode 10 can be 10% to 90%, in particular, 20% to 75%. The impregnation ratio in the hydrogen electrode 10 can be 3% to 60%, in particular, 15% to 40%. The application ratio in the first area 11 is preferably 20% to 75%. The impregnation ratio of the nickel component in the first area 11 is preferably 15% or more and less than 45%. This ensures the function of the nickel component 14 in the hydrogen electrode 10 as a catalytic component. In addition, this ensures the electrical conductivity of the hydrogen electrode 10. Therefore, the hydrogen electrode-solid electrolyte layer composite 1 can form a proton-conducting cell structure having higher current efficiency and power density.

### [Method of Manufacturing Hydrogen Electrode-Solid Electrolyte Layer Composite]

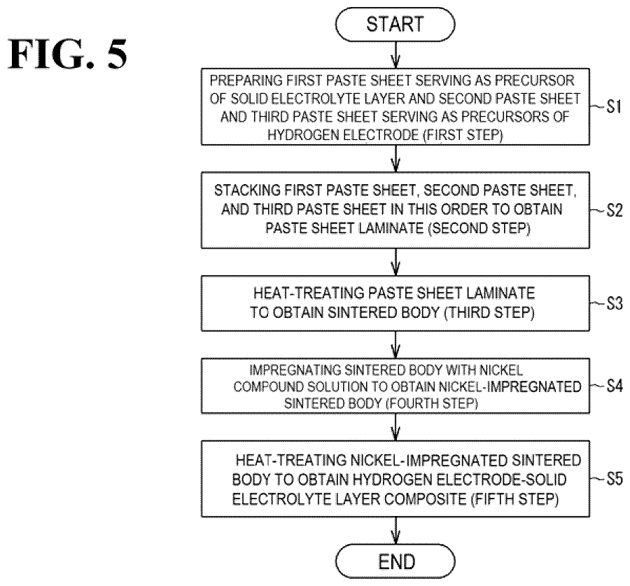

FIG. 5 is a flowchart of a method of manufacturing a hydrogen electrode-solid electrolyte layer composite 1. As illustrated in FIG. 5, the method of manufacturing the hydrogen electrode-solid electrolyte layer composite 1 includes five steps from a first step S1 to a fifth step S5.

### (First Step)

The first step S1 is a step of preparing a first paste sheet serving as a precursor of the solid electrolyte layer 20, and a second paste sheet and a third paste sheet serving as precursors of the hydrogen electrode 10. The first paste sheet contains a metal oxide and does not contain a pore-forming material. The metal oxide has a perovskite structure and is represented by the formula (1) above. The second paste sheet contains a metal oxide and a first pore-forming material. The metal oxide has a perovskite structure and is represented by the formula (1) above. The third paste sheet contains a metal oxide and a second pore-forming material. The metal oxide has a perovskite structure and is represented by the formula (1) above. The metal oxides contained in the first paste sheet, the second paste sheet, and the third paste sheet are preferably the same.

The second paste sheet is a precursor of the first area 11. The third paste sheet is a precursor of the second area 12. The first pore-forming material contained in the second paste sheet has a first median diameter. The second pore-forming material contained in the third paste sheet has a second median diameter. The first median diameter is smaller than the second median diameter. This enables manufacturing of a hydrogen electrode-solid electrolyte layer composite 1 having a first average diameter smaller than a second average diameter.

A ratio of the second median diameter to the first median diameter (second median diameter/first median diameter) can be 2.5 to 10. In the ratio, the first median diameter can be 15 μm to 50 μm, in particular, 20 μm to 45 μm. In the ratio, the second median diameter can be 30 μm to 200 μm, in particular, 35 μm to 160 μm. This enables manufacturing of a hydrogen electrode-solid electrolyte layer composite 1 having the above-described ratio of the second average diameter to the first average diameter and the above-described first average diameter and second average diameter.

The paste sheets may each contain a binder as necessary. Examples of the binder include, but are not particularly limited to, publicly known materials used in manufacturing of ceramic materials, such as polymer binders and waxes. Examples of the polymer binders include butyral resins, cellulose derivatives, vinyl acetate-based resins, and acrylic resins. Examples of the butyral resins include polyvinyl butyral. Examples of the cellulose derivatives include ethyl cellulose and cellulose ethers. The concept of the vinyl acetate-based resins also includes saponified products of vinyl acetate-based resins, such as provinyl alcohol. Examples of the waxes include paraffin wax.

The paste sheets may each contain a dispersion medium as necessary. Examples of the dispersion medium include, but are not particularly limited to, water and organic solvents. Examples of the organic solvents include hydrocarbons such as toluene; alcohols such as ethanol and isopropanol; and carbitols such as butyl carbitol acetate.

The paste sheets may each contain various additives such as surfactants, deflocculants, and plasticizers as necessary.

### (Second Step)

The second step S2 is a step of stacking the first paste sheet, the second paste sheet, and the third paste sheet in the order of the first paste sheet, the second paste sheet, and the third paste sheet to obtain a paste sheet laminate. This enables manufacturing of a hydrogen electrode-solid electrolyte layer composite 1 having a layer structure in which the solid electrolyte layer 20, the first area 11, and the second area 12 are disposed in this order. The stacking of the paste sheets may be performed by screen printing or using green sheets and is not particularly limited. The paste sheet laminate obtained in the second step S2 of the present embodiment is a laminate in which green sheets are stacked.

### (Third Step)

The third step S3 is a step of heat-treating the paste sheet laminate obtained in the second step S2 to obtain a sintered body. In the third step S3 of the present embodiment, the paste sheet laminate in which green sheets are stacked is treated at 60 °C to 80 °C and at a pressure of 20 kgf/cm² to 40 kgf/cm². Thus, the paste sheet laminate is pressure-bonded. After the pressure-bonding, the paste sheet laminate is heat-treated at 400 °C to 1,000 °C. This removes at least part of the binder, the first pore-forming material contained in the second paste sheet, and the second pore-forming material contained in the third paste sheet. Next, the paste sheet laminate after the heat treatment is further heat-treated at 1,400 °C to 1,650 °C to obtain a sintered body. Note that the heat treatment may be performed at 1,500 °C to 1,650 °C. This enables manufacturing of a hydrogen electrode-solid electrolyte layer composite 1 that can form a proton-conducting cell structure having higher current efficiency and power density. The heat treatment for removing the binder, the first pore-forming material, and the second pore-forming material may be omitted. In this case, a sintered body is obtained by heat-treating the paste sheet laminate at 1,400 °C to 1,650 °C.

### (Fourth Step)

The fourth step S4 is a step of impregnating the sintered body obtained in the third step S3 with a nickel compound solution to obtain a nickel-impregnated sintered body. The nickel compound solution may be, for example, a solution containing a nickel powder, a dispersant, and a-terpineol. The nickel powder has a particle size of, for example, 1 μm or less. The contents of the nickel powder, the dispersant, and α-terpineol are, for example, 82 mass %, 2 mass %, and 16 mass %, respectively. Through the fourth step S4, pores of the sintered body are impregnated with the nickel compound solution. The impregnation treatment with the nickel compound solution can be appropriately selected depending on the type and the state of the nickel compound solution and is not particularly limited. For example, when the nickel compound solution has a low impregnating ability, impregnation under reduced pressure, pressure impregnation, or the like is selected. When the nickel compound solution has a high impregnating ability, an impregnation method in which the nickel compound solution is dripped onto a sintered body, an impregnation method in which a sintered body is immersed in the nickel compound solution, or the like is selected. In the fourth step S4 of the present embodiment, the nickel-impregnated sintered body is obtained by dripping a nano Ni slurry, which is a nickel compound solution, onto a surface serving as the hydrogen electrode 10 in the sintered body (hereinafter, may be simply referred to as “dripping impregnation”).

The nickel compound solution is impregnated into pores of the sintered body of the second paste sheet through pores of the sintered body of the third paste sheet. As described above, the first median diameter of the first pore-forming material contained in the second paste sheet is smaller than the second median diameter of the second pore-forming material contained in the third paste sheet. Therefore, the pores of the sintered body of the third paste sheet are larger than the pores of the sintered body of the second paste sheet. The nickel compound solution easily passes through the sintered body of the third paste sheet having the large pores. This promotes impregnation of the pores of the sintered body of the second paste sheet with the nickel compound solution. As a result, the application ratio and the impregnation ratio are ensured in the first area 11 of the hydrogen electrode-solid electrolyte layer composite 1 manufactured by the manufacturing method of the present embodiment. Therefore, according to the manufacturing method of the present embodiment, a hydrogen electrode-solid electrolyte layer composite 1 that can form a proton-conducting cell structure having sufficient current efficiency and power density is manufactured.

### (Fifth Step)

The fifth step S5 is a step of heat-treating the nickel-impregnated sintered body obtained in the fourth step S4 to obtain a hydrogen electrode-solid electrolyte layer composite 1. In the fifth step S5, the nickel-impregnated sintered body is heat-treated at 200 °C to 600 °C. Through this heat treatment, the inner surfaces of the pores 13 of the hydrogen electrode-solid electrolyte layer composite 1 are covered with the nickel component 14. Furthermore, the heat treatment of the nickel-impregnated sintered body at 200 °C to 600 °C can suppress diffusion of nickel into the solid electrolyte layer 20. The heat treatment may be performed at 300 °C to 500 °C. Thus, according to the manufacturing method of the present embodiment, a hydrogen electrode-solid electrolyte layer composite 1 that can form a proton-conducting cell structure having higher current efficiency and power density is manufactured.

The impregnation treatment of the fourth step S4 and the heat treatment of the fifth step S5 can be repeated a plurality of times. This can improve the application ratio and the impregnation ratio in the hydrogen electrode 10, in particular, the first area 11.

### [Proton-Conducting Cell Structure]

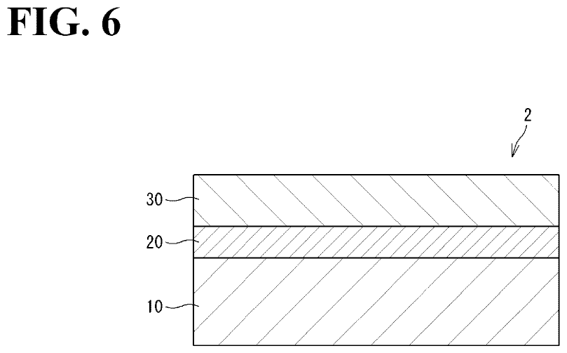

FIG. 6 is a schematic view of a proton-conducting cell structure 2 including a hydrogen electrode-solid electrolyte layer composite 1. The proton-conducting cell structure 2 includes the hydrogen electrode-solid electrolyte layer composite 1 and a porous oxygen electrode 30 in contact with the solid electrolyte layer 20. The proton-conducting cell structure 2 includes the hydrogen electrode-solid electrolyte layer composite 1 and thus has high current efficiency and power density. The proton-conducting cell structure 2 is configured such that the solid electrolyte layer 20 is disposed between the oxygen electrode 30 and the hydrogen electrode 10. The average film thickness of the oxygen electrode 30 is not particularly limited but may be from about 5 μm to about 40 μm.

The oxygen electrode 30 is composed of a compound having a perovskite structure. The compound may be a compound (such as ferrite, manganite, and/or cobaltite) having a perovskite structure containing lanthanum. Such a compound having a perovskite structure containing lanthanum may contain strontium. Specific examples thereof include lanthanum strontium cobalt ferrite (LSCF: La₁₋ₓSrₓFe_{1-y}Co_{y}O_{3-δ}, 0<x<1, and 0<y<1), lanthanum strontium manganite (LSM: La₁₋ₓSrₓMnO_{3-δ} and 0<x<1), and lanthanum strontium cobaltite (LSC: La₁₋ₓSrₓCoO_{3-δ} and 0<x<1). The oxygen electrode 30 of the proton-conducting cell structure 2 may be composed of LSCF or LSC. This provides the proton-conducting cell structure 2 with higher current efficiency and power density. Note that & represents an oxygen deficiency.

### [Method of Manufacturing Proton-Conducting Cell Structure]

The proton-conducting cell structure 2 can be manufactured by stacking a fourth paste sheet serving as a precursor of the oxygen electrode 30 on a surface of the sintered body serving as the solid electrolyte layer 20 of the hydrogen electrode-solid electrolyte layer composite 1, and performing heat treatment at 800 °C to 1,100 °C. More specifically, in the first step S1 illustrated in FIG. 5, the fourth paste sheet is further prepared. In the third step S3, of the surfaces of a first sintered body including the first paste sheet, the second paste sheet, and the third paste sheet, the fourth paste sheet is stacked on the surface of the solid electrolyte layer 20. The first sintered body on which the fourth paste sheet is stacked is heat-treated to obtain a second sintered body including a sintered body of the fourth paste sheet. The second sintered body is treated in the fourth step S4 and the fifth step S5 to obtain the proton-conducting cell structure 2.

The fourth paste sheet contains the above-described compound having a perovskite structure containing lanthanum. The fourth paste sheet may contain a catalyst such as Pt from the viewpoint of promoting the reaction between a proton and an oxide ion. The fourth paste sheet can contain, for example, the binder, the dispersion medium, and/or the additives described above as necessary.

### [Fuel Cell]

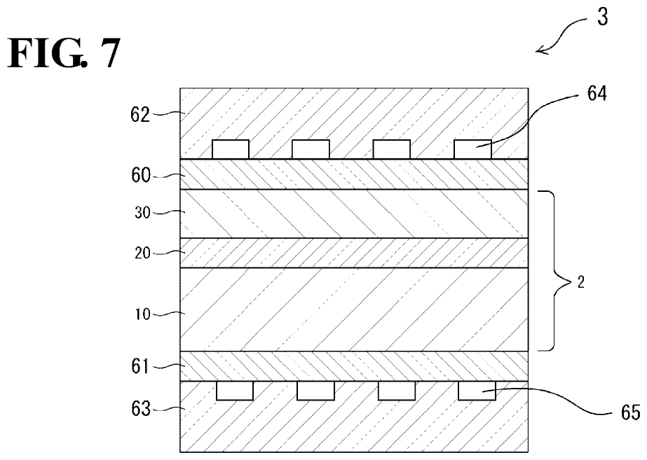

FIG. 7 is a schematic view of a fuel cell 3 including a proton-conducting cell structure 2. The fuel cell 3 according to the present embodiment may be a fuel cell having a configuration similar to those of existing fuel cells except that the proton-conducting cell structure 2 is included. Specifically, the fuel cell 3 may include a first separator 62 provided with an oxidant channel 64. For example, an oxidant is supplied from the oxidant channel 64 to an oxygen electrode 30 through a first current collector 60 close to the oxygen electrode 30 of the proton-conducting cell structure 2. The fuel cell 3 may further include a second separator 63 provided with a fuel channel 65. A fuel is supplied from the fuel channel 65 to a hydrogen electrode 10 through a second current collector 61 close to the hydrogen electrode 10 of the proton-conducting cell structure 2. The fuel cell 3 according to the present embodiment includes the proton-conducting cell structure 2 and thus has high current efficiency and power density. The fuel cell can be manufactured by a publicly known method except for the use of the proton-conducting cell structure 2.

### [Steam Electrolysis Cell]

A steam electrolysis cell according to the present embodiment may be a steam electrolysis cell having a configuration similar to those of existing steam electrolysis cells except that the proton-conducting cell structure 2 is included. For example, the same structure as that of the fuel cell illustrated in FIG. 7 can be used. The steam electrolysis cell according to the present embodiment includes the proton-conducting cell structure 2 and thus has high current efficiency and power density. The steam electrolysis cell can be manufactured by a publicly known method except for the use of the proton-conducting cell structure 2.

### OTHER EMBODIMENTS

The shape of each of the hydrogen electrode-solid electrolyte layer composite 1 and the proton-conducting cell structure 2 is a stack type but is not limited thereto. For example, the shape may be a cylindrical shape obtained by rolling the composite or the cell structure with the hydrogen electrode facing inward so as to have a hollow space.

The proton-conducting cell structure 2 is also applicable to a gas decomposition device. The gas decomposition device may be a gas decomposition device having a configuration similar to those of existing gas decomposition devices except that the proton-conducting cell structure 2 is included. The gas decomposition device can be manufactured by a publicly known method except for the use of the proton-conducting cell structure 2.

### EXAMPLES

Next, the present disclosure will be described in more detail with reference to Examples. The present disclosure is not limited to the Examples.

[Preparation of BaZr_{0.8}Y_{0.2}O_{2.9} Powder]

Barium carbonate, zirconium oxide, and yttrium oxide were placed in a ball mill in a molar ratio such that the proportion of Ba was 1.0 and the proportion of Y was 0.2 and mixed for 24 hours to obtain a mixture. The obtained mixture was calcined at 1,000 °C for 10 hours. The calcined mixture was treated in the ball mill for 10 hours, uniaxially compacted, and then fired in an air atmosphere at 1,300 °C for 10 hours. The fired sample was disintegrated in a mortar and then treated in the ball mill for 10 hours. The obtained powder was again uniaxially compacted, then fired at 1,300 °C for 10 hours, and treated in the ball mill for 10 hours to obtain a BaZr_{0.8}Y_{0.2}O_{2.9} powder (hereinafter, also referred to as a BZY powder).

### [Preparation of First Paste Sheet (Precursor of Solid Electrolyte Layer)]

In a ball mill, 100 g of the BZY powder and a dispersion medium (a mixed dispersion medium of toluene:ethanol=4:6 (parts by weight)) were mixed to obtain a mixture. To the obtained mixture, 15 g of PVB (polyvinyl butyral) serving as a binder and 4.5 g of dibutyl phthalate serving as a plasticizer were added, and mixing was further performed to obtain a slurry mixture having a viscosity of 12 Pa·s. The obtained slurry mixture was applied, by a doctor blade method, to a substrate formed of a polyester film that had been subjected to silicone treatment in air so as to have a thickness of 100 μm, and left to stand in a thermostatic chamber at 80 °C for 30 minutes to remove the solvent. Subsequently, the resulting sheet was peeled off from the substrate to obtain a first paste sheet as a green sheet having a thickness of 40 μm.

### [Preparation of Second Paste Sheet (Precursor of First Area of Hydrogen Electrode)]

In a ball mill, 50 g of the BZY powder, a pore-forming material described later, and a dispersion medium (a mixed dispersion medium of toluene:ethanol=4:6 (parts by weight)) were mixed to obtain a mixture. To the obtained mixture, 15 g of PVB (polyvinyl butyral) serving as a binder and 4.5 g of dibutyl phthalate serving as a plasticizer were added, and mixing was further performed to obtain a slurry mixture having a viscosity of 10 Pa·s. The obtained slurry mixture was applied, by a doctor blade method, to a substrate formed of a polyester film that had been subjected to silicone treatment in air so as to have a thickness of 500 μm, and left to stand in a thermostatic chamber at 80 °C for 30 minutes to remove the solvent. Subsequently, the resulting sheet was peeled off from the substrate to prepare a second paste sheet as a green sheet having a thickness of 180 μm.

### [Preparation of Third Paste Sheet (Precursor of Second Area of Hydrogen Electrode)]

In a ball mill, 50 g of the BZY powder, a pore-forming material described later, and a dispersion medium (a mixed dispersion medium of toluene:ethanol=4:6 (parts by weight)) were mixed to obtain a mixture. To the obtained mixture, 15 g of PVB (polyvinyl butyral) serving as a binder and 4.5 g of dibutyl phthalate serving as a plasticizer were added, and mixing was further performed to obtain a slurry mixture having a viscosity of 8 Pa·s. The obtained slurry mixture was applied, by a doctor blade method, to a substrate formed of a polyester film that had been subjected to silicone treatment in air so as to have a thickness of 500 μm, and left to stand in a thermostatic chamber at 80 °C for 30 minutes to remove the solvent. Subsequently, the resulting sheet was peeled off from the substrate to prepare a third paste sheet as a green sheet having a thickness of 180 μm.

### [Pore-Forming Materials]

In the above preparation of the second paste sheet and the third paste sheet, the following spherical carbons having three different median diameters were used as the pore-forming materials.
First spherical carbon: median diameter 20 μm (“ICB-2020”, manufactured by Nippon Carbon Co., Ltd.)
Second spherical carbon: median diameter 40 μm (“ICB-15020”, manufactured by Nippon Carbon Co., Ltd.)
Third spherical carbon: median diameter 100 μm (“TECHPOLYMER MBX-100”, manufactured by Sekisui Kasei Co., Ltd.)
Fourth spherical carbon: median diameter 150 μm (“ICB-15020”, manufactured by Nippon Carbon Co., Ltd.)

Table 1 shows the types and amounts of pore-forming materials added to the second paste sheet and the third paste sheet used in manufacturing of a proton-conducting cell structure of each sample.

TABLE 1

| | Second paste sheet | | Third paste sheet | |
|---|---|---|---|---|
| | | Amount added | | Amount added |
| | Type of pore-forming material | (vol %) | Type of pore-forming material | (vol %) |
| Sample number 1 | First spherical carbon | 65 | Second spherical carbon | 50 |
| Sample number 2 | First spherical carbon | 80 | Fourth spherical carbon | 80 |
| Sample number 3 | First spherical carbon | 78 | Second spherical carbon | 85 |
| Sample number 4 | Second spherical carbon | 84 | Third spherical carbon | 60 |
| Sample number 5 | Second spherical carbon | 78 | Fourth spherical carbon | 75 |
| Sample number 6 | First spherical carbon | 60 | Second spherical carbon | 45 |
| Sample number 7 | Second spherical carbon | 85 | Fourth spherical carbon | 85 |
| Sample number 8 | Second spherical carbon | 91 | Fourth spherical carbon | 90 |
| Sample number 9 | Second spherical carbon | 75 | Fourth spherical carbon | 70 |
| Sample number 10 | First spherical carbon | 75 | First spherical carbon | 75 |
| Sample number 11 | Second spherical carbon | 80 | Second spherical carbon | 80 |
| Sample number 12 | Fourth spherical carbon | 70 | Fourth spherical carbon | 70 |

### [Preparation of Sintered Body]

The first paste sheet, the second paste sheet, and the third paste sheet were stacked in this order to prepare a paste sheet laminate. The obtained paste sheet laminate was pressure-bonded at 70 °C and a pressure of 30 kgf/cm². The paste sheet laminate after the pressure-bonding was heat-treated at 800 °C for one hour in an air atmosphere to perform removal treatment of the binder and the pore-forming materials. The paste sheet laminate after the removal treatment was heat-treated at 1,500 °C for 10 hours in an air atmosphere to prepare a first sintered body.

As the material of an oxygen electrode, an LSCF (La_{0.6}Sr_{0.4}Fe_{0.8}Co_{0.2}O_{3-δ}) paste was prepared in which 50 g of a powder of LSCF, 50 g of butyl carbitol acetate serving as a dispersion medium, and 10 g of ethyl cellulose serving as a binder were mixed. The LSCF paste was applied to a surface serving as a solid electrolyte layer of the first sintered body by screen printing so as to have a thickness of 30 μm. Subsequently, heat treatment was conducted at 1,000 °C for two hours to sinter LSCF, thereby preparing a second sintered body having an oxygen electrode with a thickness of 25 μm.

### [Preparation of Proton-Conducting Cell Structure]

### (Preparation of Nickel-Impregnated Sintered Body)

A surface serving as a hydrogen electrode in the second sintered body was subjected to dripping impregnation with a nano Ni slurry containing a nano Ni powder (manufactured by Sigma-Aldrich) having a median diameter of 200 nm to prepare a nickel-impregnated sintered body. To cover the inner surfaces of pores of the hydrogen electrode, the nickel-impregnated sintered body was subjected to heat treatment at 400 °C for one hour. The above dripping impregnation and heat treatment were repeated four times to prepare a proton-conducting cell structure (φ 16 mm).

### [Measurement of Average Film Thicknesses, First Average Diameter, Second Average Diameter, Porosities, Application Ratio, and Impregnation Ratio]

The porosities, the application ratios, and the impregnation ratios of the proton-conducting cell structures of sample numbers 1 to 9 and sample numbers 10 to 12 manufactured using the second paste sheet and the third paste sheet shown in Table 1 were measured. A cross-sectional SEM photograph of each of the proton-conducting cell structures was obtained using a scanning electron microscope (“JSM-7800F” manufactured by JEOL Ltd.). The analysis of pores and a nickel component of each proton-conducting cell structure by EDX was conducted using an energy-dispersive X-ray spectrometer (“X-MAX 80 EDS system” manufactured by Oxford Instruments) attached to the above scanning electron microscope.

The average film thickness, the outer diameters of pores, the cross-sectional area of pores, the cross-sectional area of the target area, the cross-sectional length of the nickel component, the cross-sectional length of pores, the cross-sectional area of the nickel component, and the cross-sectional area of pores were obtained using a program for cross-sectional SEM photograph analysis built with Python. The first average diameter was obtained by the above-described procedure of (A-1) to (A-5). The second average diameter was obtained by the above-described procedure of (B-1) to (B-5). The porosity, the application ratio, and the impregnation ratio were obtained as values expressed as a percentage (%) by multiplying the values obtained from the formulas (2) to (4) by 100.

### [Power Characteristics and Electrolysis Evaluation of Proton-Conducting Cell Structure]

Power characteristics of the proton-conducting cell structures of sample numbers 1 to 9 and sample numbers 10 to 12 were examined by measuring the open circuit voltage (OCV) and the maximum power density. Electrolysis evaluation of each of the proton-conducting cell structures was conducted by measuring the current density and the current efficiency. In order to measure the OCV, the maximum power density, the current density, and the current efficiency, a platinum mesh with a welded lead wire was bonded to each of the surfaces of the oxygen electrode and the hydrogen electrode of each proton-conducting cell structure with platinum electrode paste. The other ends of the lead wires were connected to a measuring instrument so that the current and voltage values between the lead wires could be measured.

### (Measurement of OCV)

At an operating temperature of 600 °C, hydrogen was caused to flow as a fuel gas at 1 L/min through the hydrogen electrode of each proton-conducting cell structure, synthetic air (a mixture of oxygen and nitrogen only) with a dew point of −40 °C or lower was caused to flow at 1 L/min through the air electrode, and the OCV was measured.

### (Measurement of Maximum Power Density)

At an operating temperature of 600 °C, hydrogen was caused to flow as a fuel gas at 100 cm³/min through the hydrogen electrode of each proton-conducting cell structure, and air was caused to flow at 200 cm³/min through the air electrode. The air and hydrogen were humidified so as to have a dew point of 25 °C. The voltage was measured while the current density was changed, and the maximum power density (mW/cm²), which is the maximum value of the power density, was determined from the current density and the voltage.

### (Measurement of Current Density)

A current when a voltage of 1.3 V was applied to each proton-conducting cell structure was measured as the current density (A/cm²).

### (Measurement of Current Efficiency)

A steam electrolysis evaluation was performed at an operating temperature of 600 °C while the air electrode was humidified at 80 °C. The voltage was measured while the current density was gradually increased using an electronic load device. A current-voltage curve based on the measured voltage was obtained, and its approximation formula was determined. A current density (Ifc) at 1.3 V was calculated from the approximation formula. Next, the current density was gradually increased using a DC power supply, and the voltage at that time was read to determine a current density (Iec) at 1.3 V. The current efficiency was calculated from a formula Ifc/Iec×100.

### [Measurement Results]

Tables 2 and 3 show measurement results in the proton-conducting cell structures of sample numbers 1 to 12. The average film thickness of the first area and the average film thickness of the second area were 150 μm and 300 μm, respectively. In Table 2, the application ratio and the content ratio represent the application ratio and the content ratio in the first area.

TABLE 2

| | First area (150 μm) | | Second area (300 μm) | | | |
|---|---|---|---|---|---|---|
| | First | | Second | | Impregnation with nickel | |
| | average | | average | | Ni | Ni |
| | diameter | | diameter | | Application | Impregnation |
| | (μm) | Porosity | (μm) | Porosity | ratio | ratio |
| Sample number 1 | 15 | 62% | 34 | 44% | 21% | 15% |
| Sample number 2 | 16 | 76% | 121 | 76% | 61% | 25% |
| Sample number 3 | 15 | 75% | 32 | 80% | 75% | 30% |
| Sample number 4 | 35 | 79% | 88 | 55% | 72% | 27% |
| Sample number 5 | 34 | 73% | 123 | 71% | 69% | 38% |
| Sample number 6 | 15 | 55% | 34 | 38% | 17% | 10% |
| Sample number 7 | 33 | 79% | 119 | 78% | 86% | 50% |
| Sample number 8 | 32 | 88% | 121 | 84% | 71% | 55% |
| Sample number 9 | 35 | 71% | 122 | 66% | 11% | 5% |
| Sample number 10 | 15 | 70% | 15 | 70% | 1% | 3% |
| Sample number 11 | 34 | 74% | 34 | 74% | 6% | 10% |
| Sample number 12 | 121 | 66% | 121 | 66% | 20% | 30% |

* All the electrolyte film thicknesses are 30 μm.

TABLE 3

| | Power characteristics | | Electrolysis evaluation | |
|---|---|---|---|---|
| | | Maximum power | Current | |
| | | density | density | Current |
| | | (mW/cm²) | @1.3 V | efficiency |
| | 0 CV | @600 °C | (A/cm²) | @1.3 V |
| Sample number 1 | 1.04 | 302 | 0.52 | 70% |
| Sample number 2 | 1.05 | 340 | 0.55 | 74% |
| Sample number 3 | 1.03 | 450 | 0.83 | 82% |
| Sample number 4 | 1.08 | 410 | 0.76 | 85% |
| Sample number 5 | 1.03 | 380 | 0.62 | 79% |
| Sample number 6 | 1.12 | 101 | 0.31 | 60% |
| Sample number 7 | 1.12 | 204 | 0.24 | 51% |
| Sample number 8 | 0.92 | 130 | 0.38 | 62% |
| Sample number 9 | 1.12 | 99 | 0.1 | 22% |
| Sample number 10 | 1.1 | 2 | <0.1 | Not measured |
| Sample number 11 | 1.1 | 12 | <0.1 | Not measured |
| Sample number 12 | 0.5 | 25 | <0.1 | Not measured |

As shown in Tables 2 and 3, while the proton-conducting cell structures of sample numbers 1 to 9 had a maximum power density of 99 mW/cm² or more and a current efficiency of 22% or more, the proton-conducting cell structures of sample numbers 10 to 12 had a maximum power density of 25 mW/cm² or less and a current efficiency lower than or equal to the measurement limit. The hydrogen electrodes of the proton-conducting cell structures of sample numbers 1 to 9 each have a configuration in which the first average diameter of pores present in the first area is smaller than the second average diameter of pores present in the second area. In contrast, the hydrogen electrodes of the proton-conducting cell structures of sample numbers 10 to 12 each have a configuration in which the average diameter of pores present in the first area and the average diameter of pores present in the second area are equal to each other. This experimentally demonstrated that the proton-conducting cell structures having a configuration in which the first average diameter is smaller than the second average diameter have high current efficiency and power density.

Furthermore, Tables 2 and 3 experimentally demonstrated that the proton-conducting cell structures of sample numbers 1 to 5 each had higher power density and current efficiency, that is, a maximum power density of 302 mW/cm² or more and a current efficiency of 70% or more. In the proton-conducting cell structures of sample numbers 1 to 5, the ratio of the second average diameter to the first average diameter (second average diameter/first average diameter) is 2.1 to 7.6, the porosity in the first area is 62% to 79%, the porosity in the second area is 44% to 80%, the application ratio is 21% to 75%, and the impregnation ratio is 15% to 38%. This demonstrated that the proton-conducting cell structures having a second average diameter/first average diameter of 2.0 to 8, a porosity in the first area of 60% to 80%, a porosity in the second area of 40% to 80%, an application ratio of 20% to 75%, and an impregnation ratio of 15% to 40% have higher current efficiency and power density.

### REFERENCE SIGNS LIST

1 hydrogen electrode-solid electrolyte layer composite
2 proton-conducting cell structure
3 fuel cell
10 hydrogen electrode
11 first area
12 second area
13 pore
14 nickel component
20 solid electrolyte layer
30 oxygen electrode
40 boundary surface
41 contact surface
42 hydrogen electrode surface
50 average film thickness of hydrogen electrode
51 first average film thickness
52 second average film thickness
53 average film thickness of solid electrolyte layer
60 first current collector
61 second current collector
62 first separator
63 second separator
64 oxidant channel
65 fuel channel

1. A hydrogen electrode-solid electrolyte layer composite comprising a hydrogen electrode having pores, and a solid electrolyte layer in contact with the hydrogen electrode,
wherein the hydrogen electrode and the solid electrolyte layer each contain a metal oxide,
the metal oxide has a perovskite structure and is represented by a formula (1) below:
AₓB_{1-y}M_{y}O_{3-δ} (1)
(where element A is at least one selected from the group consisting of Ba, Ca, and Sr,
element B is at least one selected from the group consisting of Ce and Zr,
element M is at least one selected from the group consisting of Y, Yb, Er, Ho, Tm, Gd, In, and Sc,
δ is an oxygen deficiency, and 0.95=x≤1 and 0<x≤0.5 are satisfied),
the hydrogen electrode has a nickel component in the pores,
the pores have a first average diameter or a second average diameter,
in a cross-sectional view parallel to a thickness direction of the hydrogen electrode, the first average diameter is an average value of outer diameters of 10 pores having the largest outer diameters among 100 pores having 70% or more of their outer circumferences visually recognizable and selected in a region from a contact surface between the hydrogen electrode and the solid electrolyte layer to a depth of 50 μm, and the second average diameter is an average value of outer diameters of 10 pores having the largest outer diameters among 20 pores having 70% or more of their outer circumferences visually recognizable and selected in a region from a surface of the hydrogen electrode opposite to the contact surface to a depth of 200 μm, and
the first average diameter is smaller than the second average diameter.

2. The hydrogen electrode-solid electrolyte layer composite according to claim 1, wherein a ratio of the second average diameter to the first average diameter (second average diameter/first average diameter) is 2.0 to 10.

3. The hydrogen electrode-solid electrolyte layer composite according to claim 1,
wherein the first average diameter is 10 μm to 40 μm, and
the second average diameter is 30 μm to 200 μm.

4. The hydrogen electrode-solid electrolyte layer composite according to claim 1,
wherein the hydrogen electrode includes a first area including the contact surface, a second area including the surface, and a boundary surface between the first area and the second area,
in the first area, a porosity is 60% to 90%, and
in the second area, a porosity is 40% to 90%.

5. The hydrogen electrode-solid electrolyte layer composite according to claim 1,
wherein the hydrogen electrode includes a first area including the contact surface, a second area including the surface, and a boundary surface between the first area and the second area,
an average film thickness from the contact surface to the boundary surface is 50 μm to 300 μm, and
an average film thickness from the surface to the boundary surface is 200 μm to 1,000 μm.

6. The hydrogen electrode-solid electrolyte layer composite according to claim 1, wherein an application ratio of the nickel component in the pores in the first area is 20% to 75%.

7. The hydrogen electrode-solid electrolyte layer composite according to claim 1, wherein an impregnation ratio of the nickel component in the pores in the first area is 15% or more and less than 45%.

8. The hydrogen electrode-solid electrolyte layer composite according to claim 1, wherein element A is Ba, element B is Zr, and element M is Y or Yb.

9. A proton-conducting cell structure comprising:
the hydrogen electrode-solid electrolyte layer composite according to claim 1 and a porous oxygen electrode in contact with the solid electrolyte layer,
wherein the solid electrolyte layer is disposed between the oxygen electrode and the hydrogen electrode, and
the oxygen electrode is composed of a compound having a perovskite structure.

10. The proton-conducting cell structure according to claim 9, wherein the oxygen electrode is composed of lanthanum strontium cobalt ferrite or lanthanum strontium cobaltite.

11. A fuel cell comprising the proton-conducting cell structure according to claim 9.

12. A steam electrolysis cell comprising the proton-conducting cell structure according to claim 9.

13. A method of manufacturing a hydrogen electrode-solid electrolyte layer composite including a hydrogen electrode having pores, and a solid electrolyte layer in contact with the hydrogen electrode, the method comprising:
a first step of preparing a first paste sheet serving as a precursor of the solid electrolyte layer, and a second paste sheet and a third paste sheet serving as precursors of the hydrogen electrode;
a second step of stacking the first paste sheet, the second paste sheet, and the third paste sheet in an order of the first paste sheet, the second paste sheet, and the third paste sheet to obtain a paste sheet laminate;
a third step of heat-treating the paste sheet laminate to obtain a sintered body;
a fourth step of impregnating the sintered body with a nickel compound solution to obtain a nickel-impregnated sintered body; and
a fifth step of heat-treating the nickel-impregnated sintered body to obtain a hydrogen electrode-solid electrolyte layer composite,
wherein the first paste sheet contains a metal oxide,
the metal oxide has a perovskite structure and is represented by a formula (1) below:
AₓB_{1-y}M_{y}O_{3-δ} (1)
(where element A is at least one selected from the group consisting of Ba, Ca, and Sr,
element B is at least one selected from the group consisting of Ce and Zr,
element M is at least one selected from the group consisting of Y, Yb, Er, Ho, Tm, Gd, In, and Sc,
δ is an oxygen deficiency, and 0.95≤x≤1 and 0<y≤0.5 are satisfied),
the second paste sheet contains the metal oxide and a first pore-forming material having a first median diameter,
the third paste sheet contains the metal oxide and a second pore-forming material having a second median diameter, and
the first median diameter is smaller than the second median diameter.

14. The manufacturing method according to claim 13,
wherein the third step includes
heat-treating the paste sheet laminate at 400 °C to 1,000 °C to remove at least part of the first pore-forming material and the second pore-forming material, and
subsequently heat-treating the paste sheet laminate at 1,400 °C to 1,650 °C to obtain the sintered body.

15. The manufacturing method according to claim 13,
wherein the fifth step includes heat-treating the nickel-impregnated sintered body at 200 °C to 600 °C to fix a nickel component in pores of the hydrogen electrode, thereby obtaining the hydrogen electrode-solid electrolyte layer composite.

16. The manufacturing method according to claim 13, wherein a ratio of the second median diameter to the first median diameter (second median diameter/first median diameter) is 2.5 to 10.

17. The manufacturing method according to claim 16,
wherein the first median diameter is 15 μm to 50 μm, and
the second median diameter is 30 μm to 200 μm.
